(19) United States
(12) Patent Application Publication
(10) Pub. No.: US 2014/0046916 A1
(43) Pub. Date: Feb. 13, 2014

(54) CONTACT CLEANSER FOR MOBILE DEVICES

(71) Applicants: Jeffrey Woody, Onalaska, WI (US); Prasanthi Thatavarthy, Onalaska, WI (US); Babu Sathyanarayana, La Crosse, WI (US); Terrance Mihm, Holmen, WI (US)

(72) Inventors: Jeffrey Woody, Onalaska, WI (US); Prasanthi Thatavarthy, Onalaska, WI (US); Babu Sathyanarayana, La Crosse, WI (US); Terrance Mihm, Holmen, WI (US)

(73) Assignee: Business Objects Software LTD., Dublin (IE)

(21) Appl. No.: 13/572,432

(22) Filed: Aug. 10, 2012

(51) Int. Cl. G06F 17/30

(52) U.S. Cl. 707/695; 707/E17.005

(57) ABSTRACT

Reading at least one item of information stored on a mobile device that is associated with at least one contact stored on the mobile device and creating a cleaning request for the at least one read item of information associated with the at least one contact. Submitting the cleaning request to a remote web services provider for processing and receiving a response from the remote web services provider with a cleaned version of the at least one item of information associated with the at least one contact. Providing a user interface on the mobile device for viewing the cleaned version of the at least one item of information and in response to a user selection of the cleaned version of the at least one item of information, updating the corresponding unclean item of information stored on the mobile device to the cleaned version of said item of information.

### BACKGROUND

Applications that manage contacts on a mobile computing device (e.g. ANDROID, IOS®, etc.) may have several items of information associated with a contact, for example one or more addresses (work, home, etc.) for each contact. This information may often need to be synchronized with a work or home database. Users may initially enter contact information into their mobile device because they have it on hand or because it may be important to many of the applications running on the device such as calling, texting, global positioning system (GPS) navigation, email, and others. Contacts from other accounts such as FACEBOOK® or a user's Gmail™ can also be part of the mobile device's contact list depending on the device and its operating system or the contacts may be synchronized from the mobile device to these and other accounts. For example, a salesperson may enter a client's contact information onto his smart phone and then later synchronize the information with his client data at a work database. This information can then be used for navigation from the mobile device (via the applications running on the device) and might be used in other ways after synchronizing with a work database, for example in promotional mailings, billing or shipping, etc.

Typically, the contact applications on mobile devices have very relaxed data entry for inputting a contact's information including his address(es). No specific or minimum amount of information is required and minimal validation, if any, is done on the address data (or other data such as telephone numbers) entered. Therefore if users enter incorrect or incomplete address information, it can be less usable for the navigation applications running on the user's mobile device. Furthermore, incomplete or incorrect information entered into a mobile device may eventually pollute a work or home database if it is synchronized with these or other databases.

### SUMMARY OF THE INVENTION

Information that is incomplete or incorrect or undesirable for some other reason may be referred to as “dirty” and instead of synchronizing dirty contact information to a work database and then waiting for the work data to be “cleansed” (for example by addressing the reasons for which the contact is undesirable) later and then somehow re-synchronized back on a mobile device such as a smart phone or tablet, a mobile application may perform data quality cleansing for contacts stored on the mobile device.

First the contacts on the mobile device are read and each contact is queried to determine if that contact has one or more addresses (or other data to be cleansed). A remote service request is built for each contact and address combination. The contact-address requests are submitted to a real-time data services service (possibly provided via cloud computing, i.e. the delivery of computing and storage capacity as a service) for processing, i.e. cleansing. The cleansed contact-address are returned to the device where the old and new addresses are displayed in a user interface on the mobile device. The user may then choose which contact-addresses to update—either all at once or individually. Any contact-addresses the user chooses to fix are updated in the contacts list on the mobile device.

### BRIEF DESCRIPTION OF THE DRAWINGS

FIG. 1 shows an example system and processing flow according to the present invention.

FIG. 2 shows an example method according to the present invention.

FIG. 3A shows an example screenshot of a mobile device's contact application displaying a partial list of contacts stored on the mobile device.

FIG. 3B shows an example screenshot of a mobile device's contact application displaying the information associated with a single contact stored on the mobile device.

FIG. 4A shows an example screenshot of an application for cleansing contact information according to the present invention displaying a progress dialog.

FIG. 4B shows an example screenshot of an application for cleansing contact information according to the present invention displaying an initial contacts list.

FIG. 5 shows an example screenshot of an application for cleansing contact information according to the present invention in which a contact has been expanded to see its original address and suggested corrected/enhanced address.

FIG. 6 shows an example screenshot of an application for cleansing contact information according to the present invention displaying a contact with multiple, foreign addresses.

FIG. 7 shows an example screenshot of an application for cleansing contact information according to the present invention displaying a prompt to accept or cancel a contact update.

FIG. 8 shows an example screenshot of an application for cleansing contact information according to the present invention displaying the result of updating an address.

FIG. 9 shows an example screenshot of an application for cleansing contact information according to the present invention displaying an address that cannot be cleansed.

FIG. 10 shows an example screenshot of an application for cleansing contact information according to the present invention.

FIG. 11 shows an example screenshot of an application for cleansing contact information according to the present invention.

### DETAILED DESCRIPTION

Embodiments of the present invention will now be described in detail, by way of example only, with reference to the accompanying drawings in which identical or corresponding parts/features are provided with the same reference numerals in the figures.

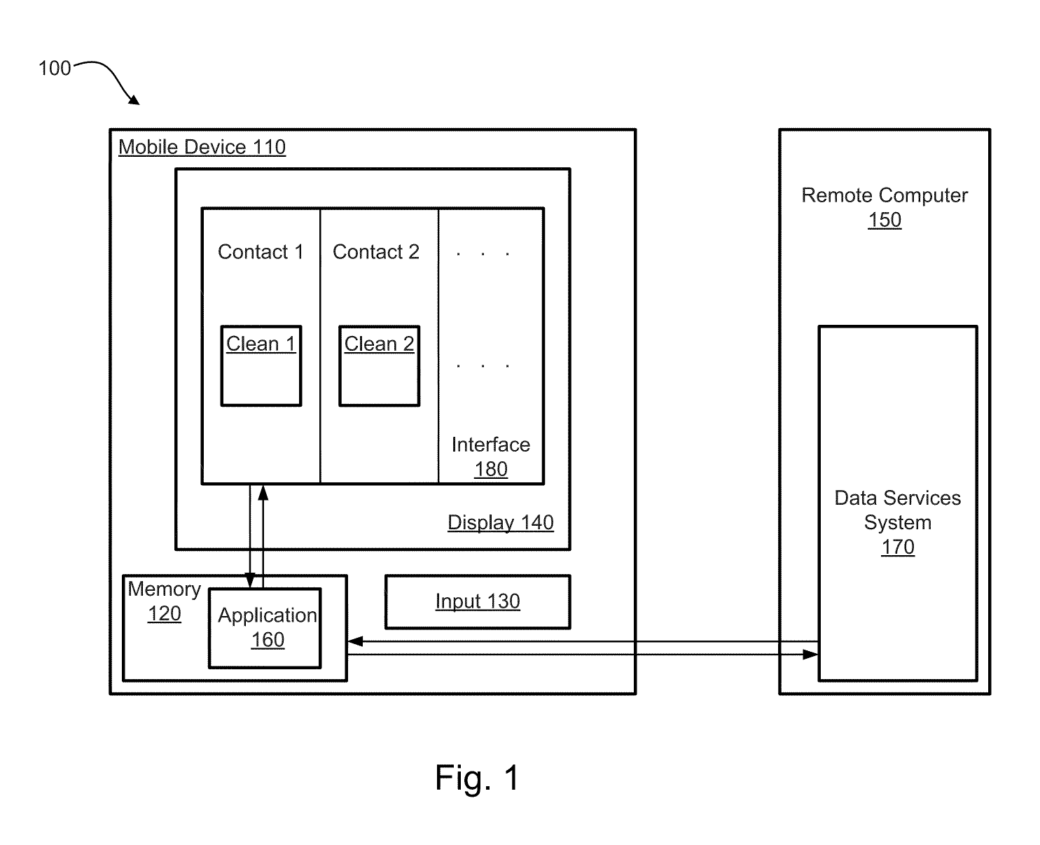

FIG. 1 shows an example computer system 100 for retrieving, cleaning and displaying information associated with contacts stored on a mobile computing device 110. Mobile device 110 typically includes a system memory 120 including both volatile and nonvolatile, removable and non-removable media implemented in any method or technology for storage of information such as computer readable instructions, data structures, program modules or other forms of data. A user may enter commands and information into the mobile device 110 through input device 130 such as a keyboard, a microphone, a pointing device, etc. Mobile device 110 may include a display 140 for displaying information to the user although it may also include other peripheral output devices such as speakers and printers.

The mobile device 110 includes a contact cleanser application 160 with an interface 180 configured to be operational with general purpose or special purpose mobile computing devices such as smart phones. The mobile device 110 may operate in a networked environment using logical connections to one or more remote computers, such as a remote computer 150 (e.g. a server). The remote computer 150 may be a network PC connected via a local area network (LAN) and/or a wide area network (WAN) or may also be connected via other networks such as the World Wide Web.

Computer system 100 includes a data services (e.g. address cleanser) system 170 stored on remote computer 150. As shown in FIG. 1 contact cleanser application 160 is in communication with the data services system 170. The contact cleanser application 160 interfaces with data services system 170 through an application interface 180. For example, the contact cleanser application 160 may interface with a data services system 170 providing a web service using the SAP® Global Address Cleanse (GAC) transform.

The contact cleanser application 160 may read items of information from mobile device 110 that are associated with one or more of the contacts (Contact 1, Contact 2, . . . ) stored on the device 110. The contact cleanser application 160 may read the information using the operating system's software development kit (SDK) or the SDK of another contacts application running on the device. For example, the contacts on the mobile device 110 may each be queried to determine if that contact has one or more addresses. Any contact which has no addresses may be filtered out from consideration. Contact cleanser application 160 may then generate cleaning requests for each item of retrieved information and transmit the requests to data services system 170. For example, a web service request may be built for each contact and address combination and the contact-address requests may be submitted to a real-time SAP® Data Services web service using the GAC transform (and/or others) for processing. Data services system 170 may then respond to each request by transmitting “clean” versions of each item, for example versions with completed or corrected information. The clean contact-address responses (Clean 1, Clean 2, . . . ) may then be returned to the mobile device 110 where the respective old and new address information for each contact may be displayed in the user interface 180 on the mobile device 110. The user may select, through the user interface 180, which contact-addresses to update—either all at once or individual selections. Any contact-addresses the user wishes to update may be modified by contact cleanser application 160 in the contacts list on the mobile device 110 using the SDK.

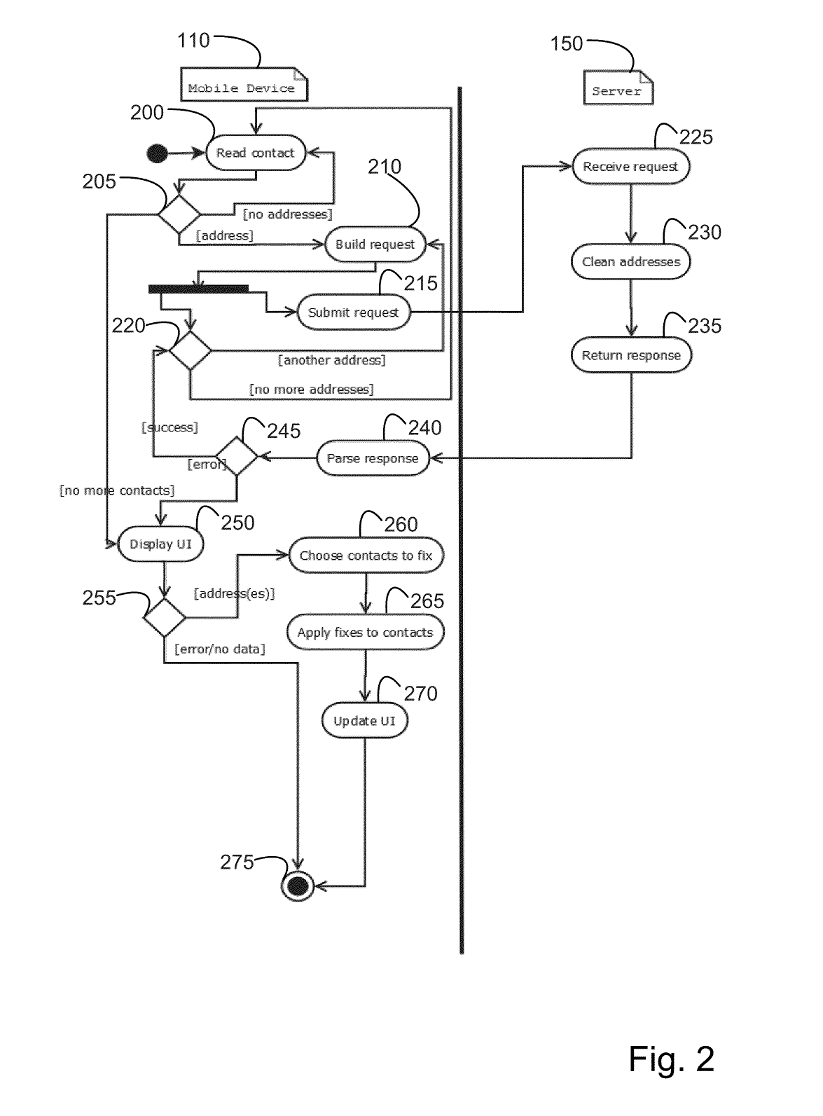

FIG. 2, illustrates an example method for retrieving, cleaning and displaying information associated with contacts stored on mobile computing devices like mobile device 110. In a step 200 the contacts on the mobile device 110 are read (i.e. the information associated with each contact is retrieved), in this example the addresses associated with each contact are read by a contact cleanser application running on the mobile device 110. In a step 205 any contact which has no addresses may be filtered out from consideration and if there are no more contacts stored on the mobile device the user interface for the contact cleanser may be displayed in a later step (250). In a step 210 cleaning requests for each address may then be built. In a step 215 each cleaning request may be submitted to a data services system on a remotes server like remote computer 150. In a step 220, which may be performed simultaneously with step 215, if there is another address associated with a contact it may be read and a cleaning request built for it (in a step 210) and if there are no more addresses for a contact then the next contact may be read (in a step 210). In a step 225, the cleaning requests may be received by the remote server. In a step 230 the addresses associated with each contact is “cleaned”, for example errors and/or omissions are corrected or formatting is performed. In a step 235 the “clean” versions of each address are returned to the requesting mobile device. In a step 240 the clean contact-address responses may be parsed as necessary for use by the contact cleanser. In a step 245, if there is no error the method continues reading addresses and building cleaning requests, i.e. return to step 220 and if there is an error this fact can be provided to the user in a later step, i.e. step 250. In step 250 the user interface for the contact cleanser may displayed on the mobile device. In a step 255, if there are no error-free cleaned addresses returned to the mobile device then the method proceeds to step 275, and if there are error-free cleaned addresses then these may be provided to the user in a later step, i.e. step 260. In step 260 the respective old and new address information for each contact may be displayed in the user interface so that a user may select which contact-addresses to update—either all at once or individual selections. In a step 265 any contact-addresses the user wishes to update may be modified by the contact cleanser in the contacts list on the mobile device. In a step 270 the user interface for the contact cleanser is updated to display the address information as updated by the user in the previous step. In a step 275 the method ends.

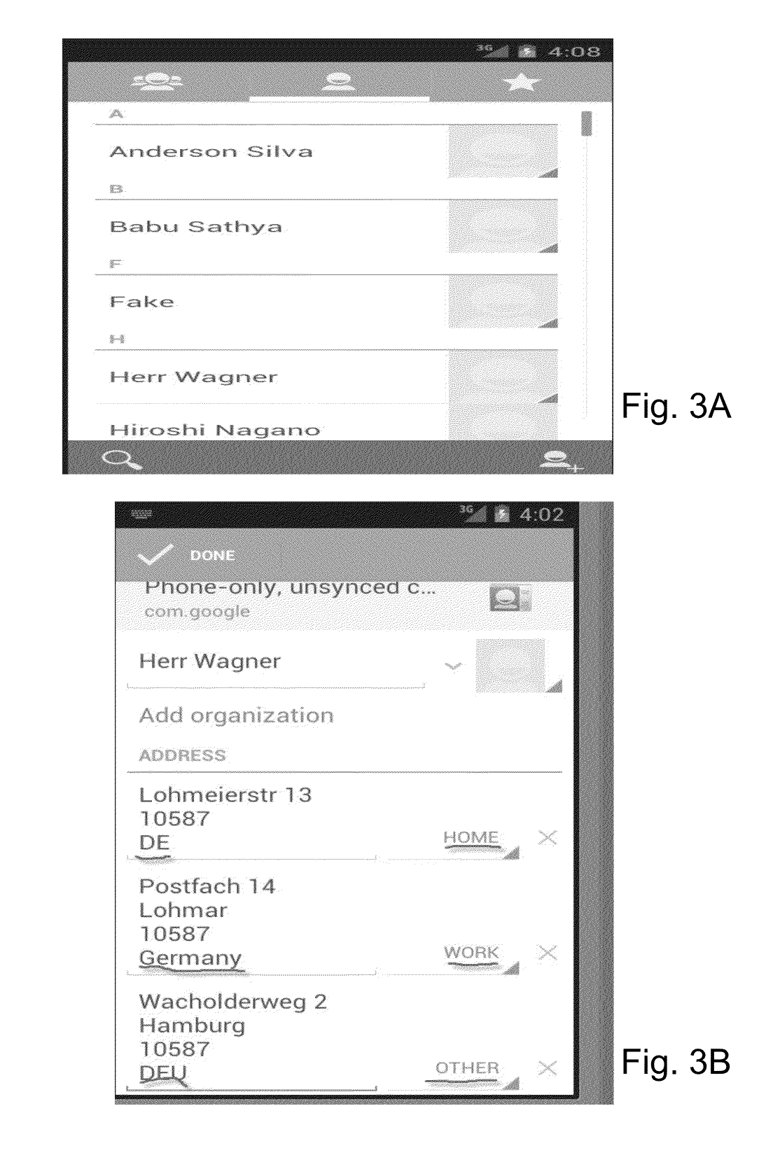

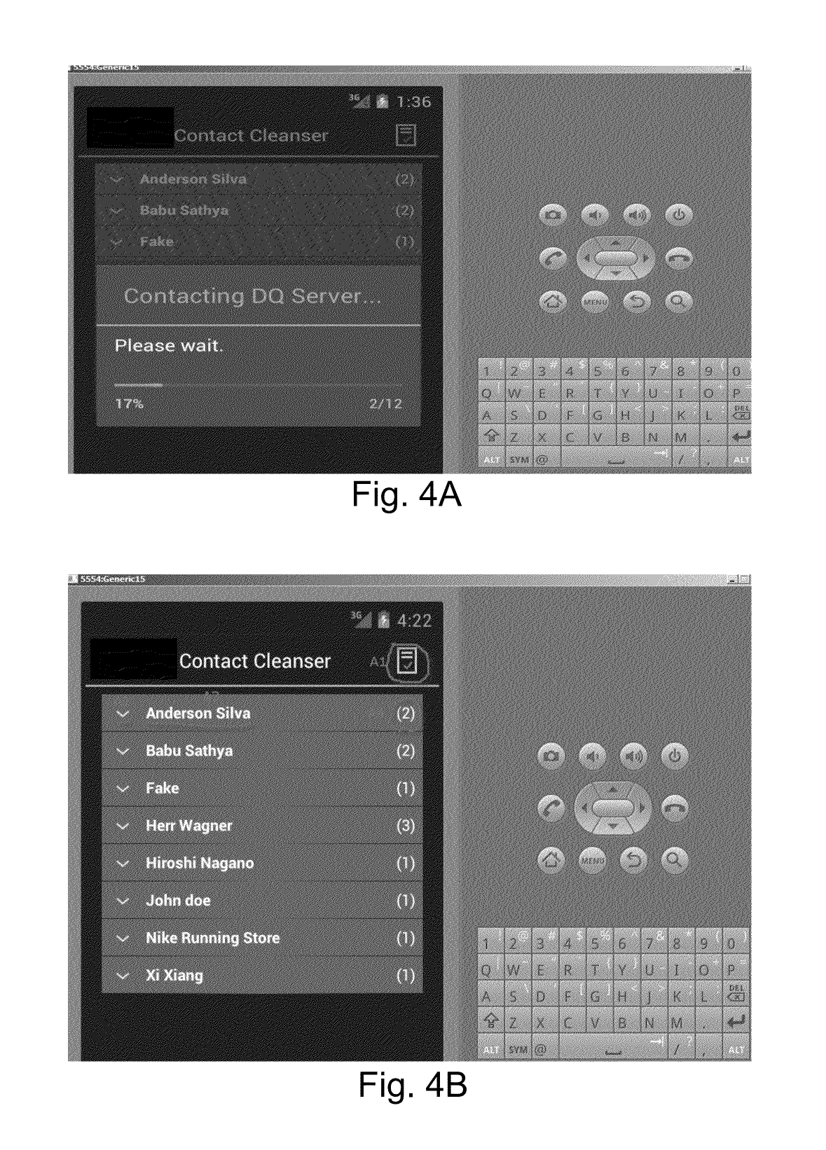

The present invention may be implemented, for example, using a “Contact Cleanser” application which includes the ability to read and render contact information included in the contact application of the Android operating system for mobile devices and communicate with a remote data services system in order to “clean” the contact information. FIG. 3A shows a partial list of contacts stored on a mobile device shown from the device's contact application. FIG. 3B shows a single contact with several German addresses are shown inside of the device's contact application, as highlighted by the underlining the designations for Germany in each of the addresses is different. FIG. 4A shows a progress dialog shown for the Contact Cleanser as the cleaning request is built for each contact's addresses(s) and submitted to the server. The progress dialog may be shown until the cleaned responses are received. FIG. 4B shows a screen displayed after the cleansed addresses are returned is the Contacts Screen. A1 is a menu button the renders differently depending on the device's resolution such that if there is enough room “Update All” may be displayed next to it (or a localized equivalent string). A2 is an expander button that allows the user to expand and collapse the addresses under the contact A3. A4 indicates the number of addresses the contact A3 has.

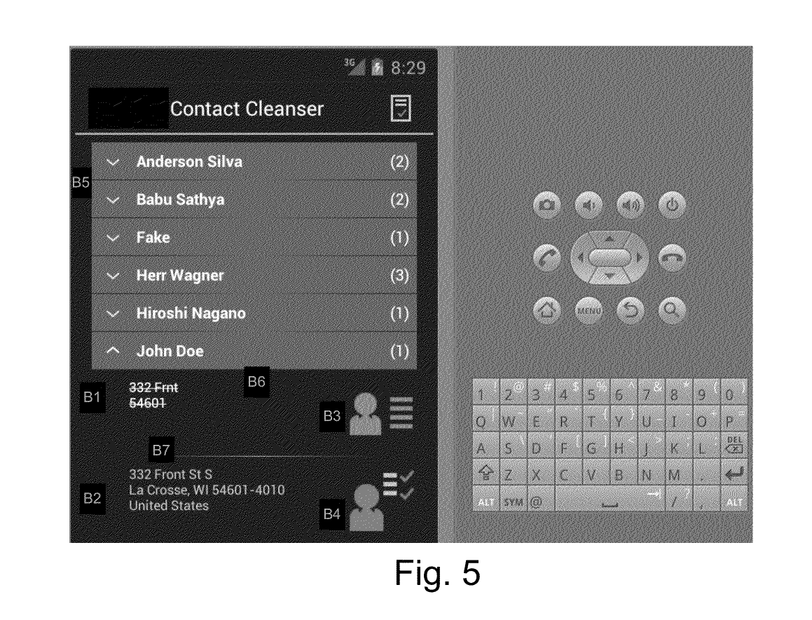

FIG. 5 shows how when a contact is expanded, its addresses are revealed. Each child (address) row is rendered in a custom way to allow for easy comparison. B1 shows a contact's original, uncorrected address in strikethrough text. The icon B3 is another visual clue to indicate the address is unchanged. B7 is an old-new gradient-line separator and B6 is a solid line to separate contacts. B2 indicates what the address cleansing can fix in the contact's address. Note that its icon B4 looks different than B3 to indicate change. Note also that a misspelled street has been corrected from “Frnt” to “Front”. A post-directional “S” for South has been added. The city and region—“La Crosse, Wis.” have been added, and the ZIP4 postal code “4010” and country have also been added. In this way the user can quickly compare old and new, corrected addressed and either accept everything that can be fixed or make individual selections as shown in some of the following screens.

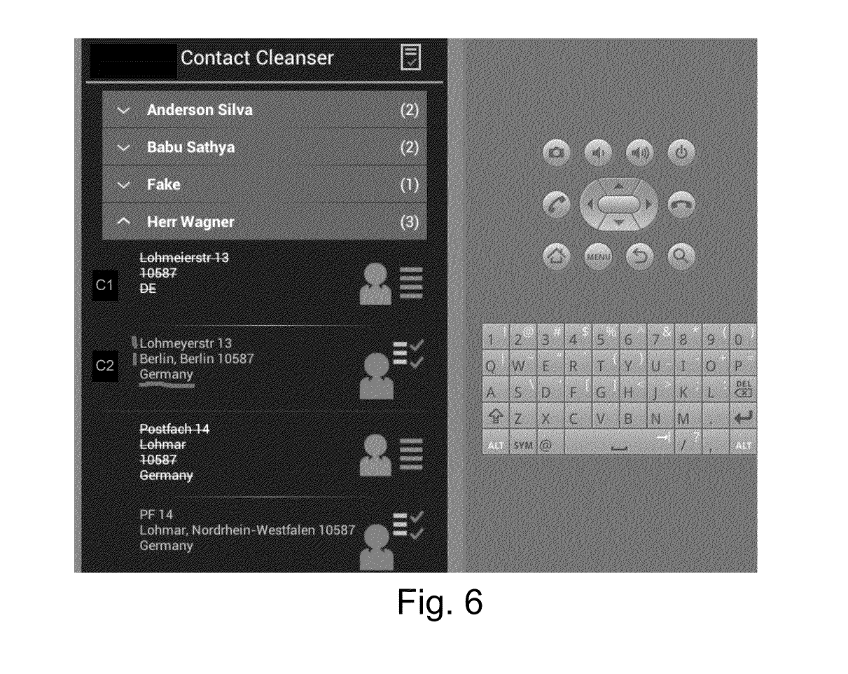

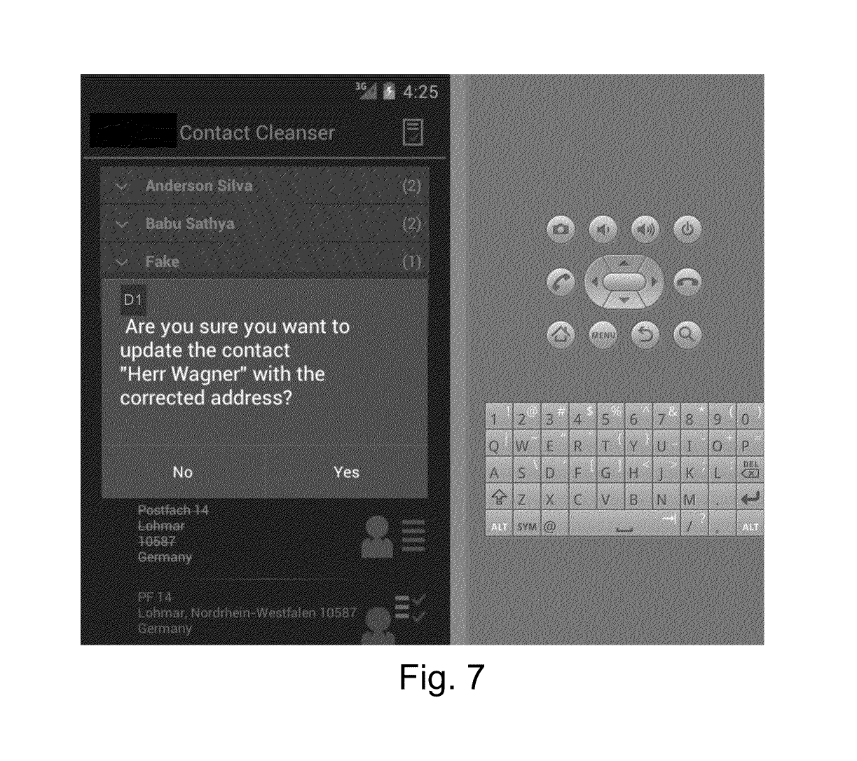

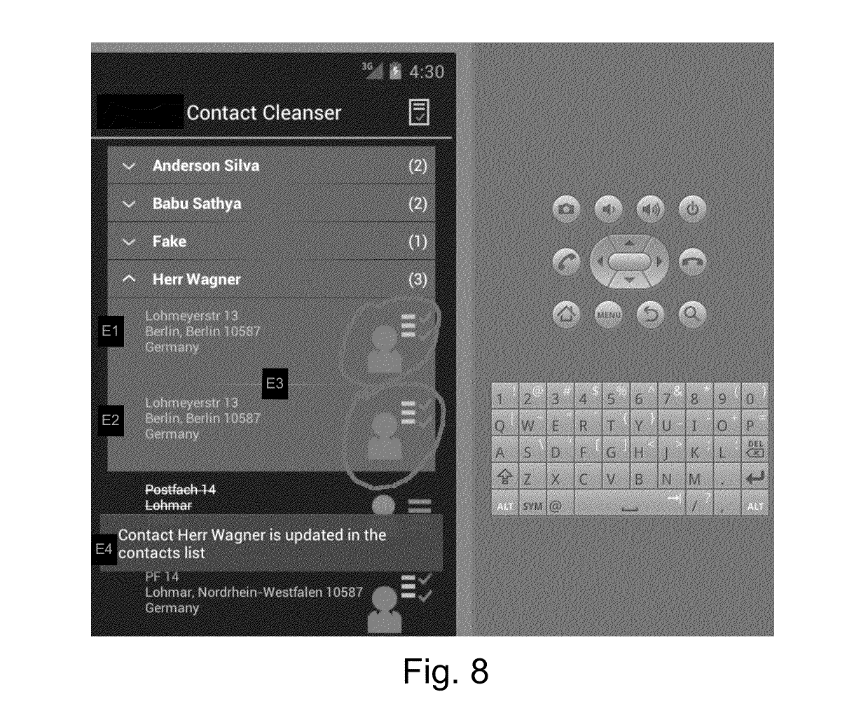

FIG. 6 shows an expanded contact that has multiple addresses. Again, C1 is the original, and C2 is the corrected address. This time the address is from a contact in Germany. If the user touches the row containing C1 and C2 a prompt is displayed as shown in the next figure. FIG. 7 shows the prompt that results from a touch gesture to the C1 and C2 rows from the previous FIG. 6. If the user selects “Yes” the contact address on the device is updated. Selecting “No” cancels the selection and nothing is changed. The action may also be invoked from the device's menu button or equivalent. FIG. 8 shows the result after an address was selected and accepted for updating. E1 used to be the original address—now, it looks the same as the corrected address E2 including its icon. Also note that the row's background has become darker to indicate it is “done” or updated. E3 is a old-new gradient-line separator. Toward the bottom, E4 is a “toast” notification that is also displayed to tell the user that the contact has been updated on the device.

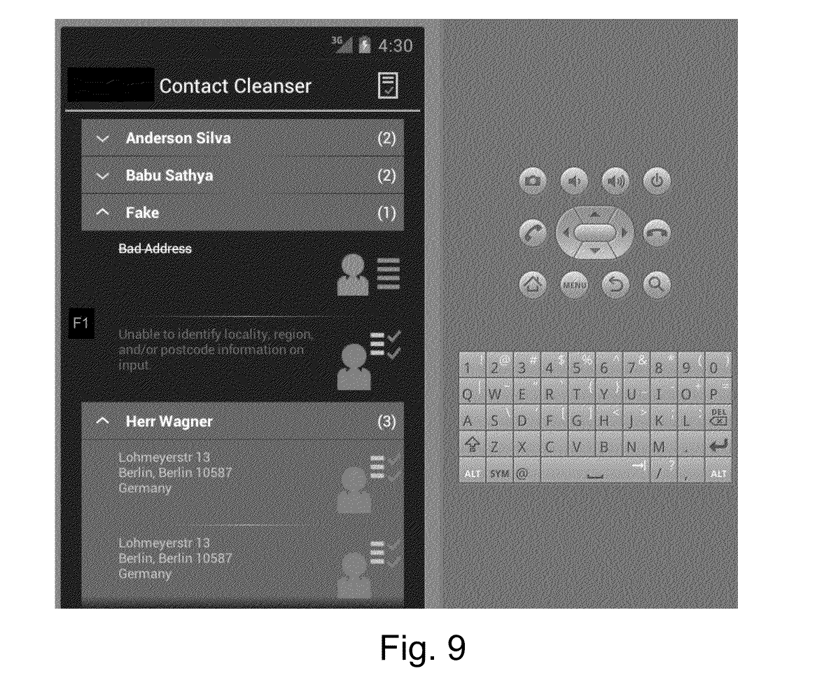

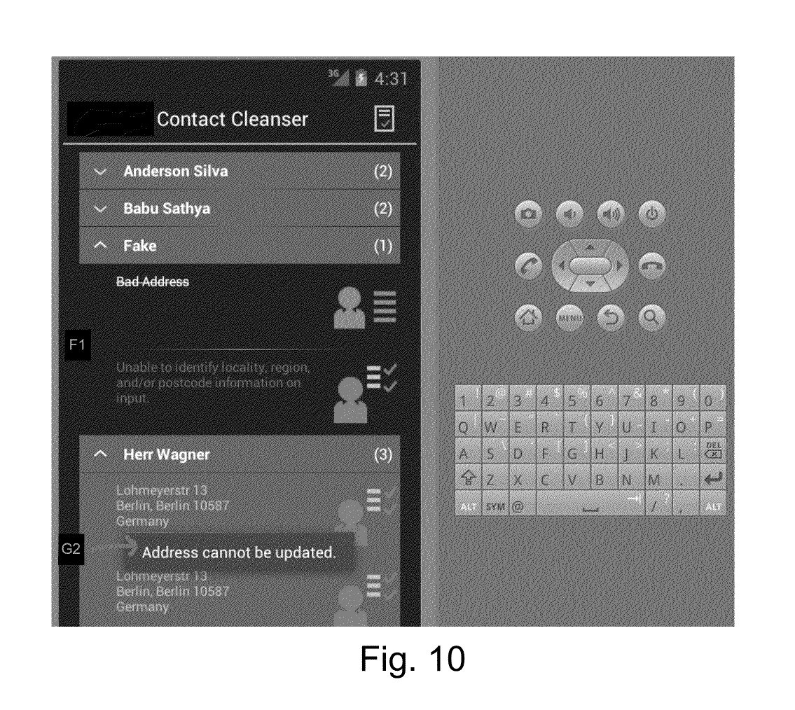

FIG. 9 shows that if there is not enough information to properly find and correct an address, an error message F1 is displayed as to the cause underneath the original address. The messages coming back from Global Address Cleanse could be replaced with simpler, more user-friendly or mobile-user targeted messages. The message F1 is shown instead of filtering out the address, so the user can see what is wrong with it and can possibly enter a little more information, so it will be enough to be correctable. FIG. 10 shows error message F1 and a toast message G2 when the user tries to update a bad address.

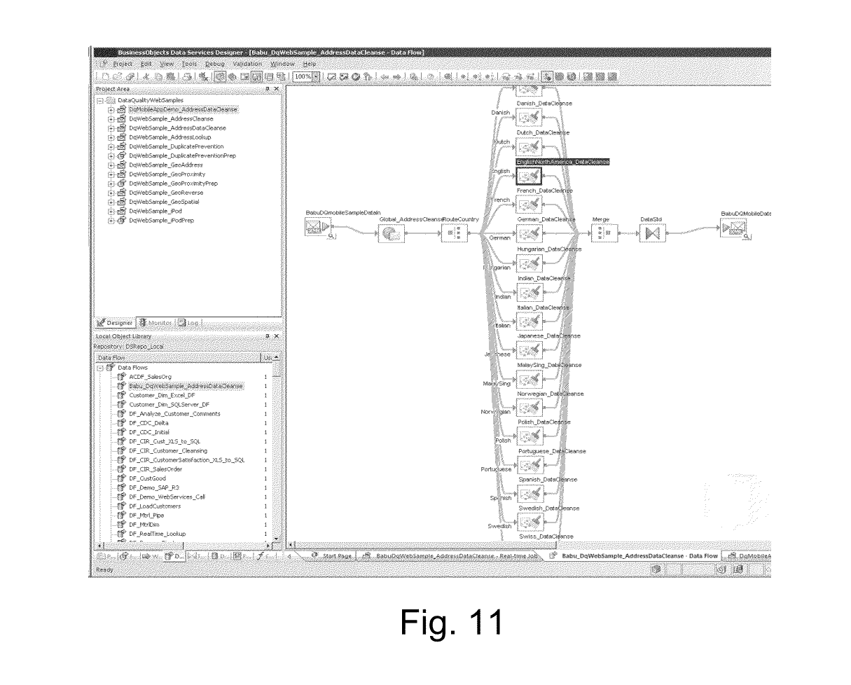

All of the cleansing may be performed by an SAP® Data Services real-time dataflow using the GAC transform. The real-time dataflow used on the server uses primarily the Global Address Cleanse transform to perform all of the data quality cleansing operations. The real-time dataflow is exposed using a protocol (e.g. SOAP) for accessing a web service provided by SAP® Data Services. The dataflow shown in FIG. 11 may use the SAP® Universal Data Cleanse (UDC) and Match transforms to provide some additional cleansing possibilities including date and phone number formatting for various countries, for example.

The Data Services real-time dataflow expects a SOAP request that looks as follows:

<soapenv:Envelope
xmlns:soapenv=“http://schemas.xmlsoap.org/soap/envelope/
xmlns:dqw=“DqWebSample”>
<soapenv:Header/>
<soapenv:Body>
<dqw:DqWebSampleAddressDataCleanseIn>
<dqw:COUNTRY>USA</dqw:COUNTRY>
<dqw:ADDRESS1>332 front</dqw:ADDRESS1>
<dqw:ADDRESS2>54601</dqw:ADDRESS2>
<dqw:ADDRESS3></dqw:ADDRESS3>
<dqw:ADDRESS4></dqw:ADDRESS4>
<dqw:ADDRESS5></dqw:ADDRESS5>
<dqw:ADDRESS6></dqw:ADDRESS6>
<dqw:CONTACT1></dqw:CONTACT1>
<dqw:CONTACT2></dqw:CONTACT2>
<dqw:CONTACT3></dqw:CONTACT3>
<dqw:CONTACT4></dqw:CONTACT4>
<dqw:CONTACT5></dqw:CONTACT5>
<dqw:CONTACT6></dqw:CONTACT6>
<dqw:CONTACT7></dqw:CONTACT7>
<dqw:CONTACT8></dqw:CONTACT8>
</dqw:DqWebSampleAddressDataCleanseIn>
</soapenv:Body>
</soapenv:Envelope>

The Data services real-time dataflow returns a SOAP response that looks as follows:

<soapenv:Envelope
xmlns:soapenv=“http://schemas.xmlsoap.org/soap/envelope/”
xmlns:xsd=“http://www.w3.org/2001/XMLSchema”
xmlns:xsi=“http://www.w3.org/2001/XMLSchema-instance”>
<soapenv:Body>
<ns1:DqWebSampleAddressDataCleanseOut xmlns:ns1=
“DqWebSample”>
<ns1:COUNTRY>United States</ns1:COUNTRY>
<ns1:BUILDING_NAME/>
<ns1:ADDRESS_DELIVERY>332 Front
St S</ns1:ADDRESS_DELIVERY>
<ns1:ADDRESS_DUAL/>
<ns1:POSTCODE_FULL>54601-4010</ns1:POSTCODE_FULL>
<ns1:LOCALITY1>La Crosse</ns1:LOCALITY1>
<ns1:LOCALITY2/>
<ns1:LOCALITY3/>
<ns1:LOCALITY4/>
<ns1:REGION>WI</ns1:REGION>
<ns1:ADDR_INFO_CODE_DESC/>
<ns1:QUALITY_CODE>Q1</ns1:QUALITY_CODE>
<ns1:PERSON1></ns1:PERSON1>
<ns1:PERSON2/>
<ns1:PERSON3/>
<ns1:TITLE1/>
<ns1:TITLE2/>
<ns1:TITLE3/>
<ns1:FIRM1></ns1:FIRM1>
<ns1:FIRM2/><ns1:FIRM3/>
<ns1:EMAIL1></ns1:EMAIL1>
<ns1:EMAIL2/>
<ns1:EMAIL3/>
<ns1:PHONE1></ns1:PHONE1>
<ns1:PHONE2/>
<ns1:PHONE3/>
<ns1:DATE1/>
<ns1:DATE2/>
<ns1:DATE3/>
<ns1:SSN1/>
<ns1:SSN2/>
<ns1:SSN3/>
<ns1:EXTRA1/>
<ns1:EXTRA2/>
<ns1:EXTRA3/>
<ns1:EXTRA4/>
<ns1:EXTRA5/>
<ns1:EXTRA6/>
<ns1:EXTRA7/>
<ns1:EXTRA8/>
<ns1:EXTRA9/>
<ns1:EXTRA10/>
<ns1:EXTRA11/>
<ns1:EXTRA12/>
</ns1:DqWebSampleAddressDataCleanseOut>
</soapenv:Body>
</soapenv:Envelope>

The input for each request may be built up with strings obtained from the contacts database on the device. The responses are parsed and stored in memory until the user selects one or more contacts to update, at which time the corrections are applied back to the contacts database on the device. The input request may only require a COUNTRY, and one or more of the ADDRESS(1 . . . 6) fields as input. The response returns the parsed out fields as described in the tags. The QUALITY_CODE is used to determine if the parsed information is good enough to display and use for updating to the contact. The ADDR_INFO_CODE_DESC is used to display any error as to why an address could not be cleansed.

Although the contact information may be submitted one at a time it may be possible to package all the information into one big request or at least combine some of the requests together. Furthermore a revert button or menu option could be added to undo changes for a contact. Still further a database could be stored on the device to track records that have already been cleansed, so that only new contacts need to be re-submitted. One disadvantage is that reference data changes over time, so if a street got renamed for example, you would then want a previously cleansed contact to be cleansed again. This could be addressed by including contact that are too “old”, e.g. older than a specified time period, for cleaning as well.

Embodiments of the present invention are described in the context of a fully functional computer system, however those skilled in the art will appreciate that modules of the present invention are capable of being distributed in a variety of forms across a plurality of systems. Embodiments consistent with the invention may also include one or more programs or program modules on different computing systems running separately and independently of each other, while in their entirety being capable of performing business transactions in a large enterprise environment or in a “software on demand” environment in which software and associated data are centrally hosted in the “cloud”. These programs or program modules may be contained on signal bearing media that may include: recordable type media such as floppy disks and CD ROMS, and transmission type media such as digital and analog communication links, including wireless communication links.

The foregoing description is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

1. A method for cleaning contact information on a mobile computing device, the method comprising:
reading at least one item of information stored on a mobile device that is associated with at least one contact stored on the mobile device;
creating a cleaning request for the at least one item of information associated with the at least one contact;
submitting the cleaning request to a remote web services provider for processing;
receiving a response from the remote web services provider with a cleaned version of the item of information associated with the at least one contact;
displaying a user interface on the mobile device for viewing the cleaned version of the item of information associated with the at least one contact; and
in response to a user selection of the cleaned version of the item of information associated with the at least one contact, updating the corresponding unclean item of information stored on the mobile device to the cleaned version of said item.

2. The method of claim 1, wherein the at least one item of information stored on the mobile device that associated with the at least one contact stored on the mobile device is an address or a phone number.

3. The method of claim 1, further comprising:
if more than one item of information is associated with the at least one contact creating a single cleaning request for all of the items of information associated with the at least one contact.

4. The method of claim 1, further comprising:
in response to a user selection of the updated version of the item of information associated with the at least one contact stored on the mobile device, reverting said updated version of the item of information to the previous version of said updated item of information stored on the mobile device.

5. The method of claim 1, wherein the submitting of the cleaning request to a remote web services provider for processing is performed only if the at least one item of information that has not been cleaned for at least a defined period of time.

6. The method of claim 1, further comprising:
in response to a user selection of the at least one item of information associated with the at least one contact stored on the mobile device, informing the user about any possible duplicate contacts stored on the mobile device and providing the user with the option to merge the duplicate contacts.

7. A non-transitory computer-readable medium having stored thereon instructions adapted to be executed by a processor, the instructions which, when executed, cause the processor to perform a method for cleaning contact information on a mobile computing device, comprising:
reading at least one item of information stored on a mobile device that is associated with at least one contact stored on the mobile device;
creating a cleaning request for the at least one item of information associated with the at least one contact;
submitting the cleaning request to a remote web services provider for processing;
receiving a response from the remote web services provider with a cleaned version of the item of information associated with the at least one contact;
displaying a user interface on the mobile device for viewing the cleaned version of the item of information associated with the at least one contact; and
in response to a user selection of the cleaned version of the item of information associated with the at least one contact, updating the corresponding unclean item of information stored on the mobile device to the cleaned version of said item.

8. The computer-readable medium claim 7, wherein the at least one item of information stored on the mobile device that associated with the at least one contact stored on the mobile device is an address or a phone number.

9. The computer-readable medium of claim 7, further comprising:
if more than one item of information is associated with the at least one contact creating a single cleaning request for all of the items of information associated with the at least one contact.

10. The computer-readable medium of claim 7, further comprising:
in response to a user selection of the updated version of the item of information associated with the at least one contact stored on the mobile device, reverting said updated version of the item of information to the previous version of said updated item of information stored on the mobile device.

11. The computer-readable medium of claim 7, wherein the submitting of the cleaning request to a remote web services provider for processing is performed only if the at least one item of information that has not been cleaned for at least a defined period of time.

12. The computer-readable medium of claim 7, further comprising:
in response to a user selection of the at least one item of information associated with the at least one contact stored on the mobile device, informing the user about any possible duplicate contacts stored on the mobile device and providing the user with the option to merge the duplicate contacts.

13. A system for cleaning contact information on mobile computing devices, comprising:
at least one remote web services provider including a processor and memory; and
a mobile computing device including a processor, memory and a display; and
an application program running on the at least one mobile device and providing a user interface for browsing information associated with contacts stored on the mobile device;
wherein, the system is configured to:
read at least one item of information stored on a mobile device that is associated with at least one contact stored on the mobile device;
create a cleaning request for the at least one item of information associated with the at least one contact;
submit the cleaning request to a remote web services provider for processing;
receive a response from the remote web services provider with a cleaned version of the item of information associated with the at least one contact;
display a user interface on the mobile device for viewing the cleaned version of the item of information associated with the at least one contact; and
in response to a user selection of the cleaned version of the item of information associated with the at least one contact, update the corresponding unclean item of information stored on the mobile device to the cleaned version of said item.

14. The system of claim 13, further configured to read at least one address or phone number stored on the mobile device that is associated with at the least one contact stored on said mobile device.

15. The system of claim 13, further configured to:
if more than one item of information is associated with the at least one contact creating a single cleaning request for all of the items of information associated with the at least one contact.

16. The system of claim 15, further configured to:
in response to a user selection of the updated version of the item of information associated with the at least one contact stored on the mobile device, reverting said updated version of the item of information to the previous version of said updated item of information stored on the mobile device.

17. The system of claim 16, further configured to submit the cleaning requests to a remote web services provider for processing only if the at least one item of information that has not been cleaned for at least a defined period of time.

18. The system of claim 16, further configured to:
in response to a user selection of the at least one item of information associated with the at least one contact stored on the mobile device, informing the user about any possible duplicate contacts stored on the mobile device and providing the user with the option to merge the duplicate contacts.

19. The method of claim 1, wherein the cleaned version of the item of information has been includes one of a date, a phone number and an address that has been at least one of reformatted, respelled, and corrected typographically with respect to the original version of the item of information.

20. The method of claim 19, wherein the at least one of reformatting, respelling and typographical correcting includes comparing the at least one item of information against a database of known values.
